(19) United States
(12) Patent Application Publication
(10) Pub. No.: US 2019/0254490 A1
(43) Pub. Date: Aug. 22, 2019

(54) VACUUM CLEANER AND TRAVEL CONTROL METHOD THEREOF

(71) Applicant: TOSHIBA LIFESTYLE PRODUCTS & SERVICES CORPORATION, Kawasaki-shi (JP)

(72) Inventors: Yuuki MARUTANI, Nagakute (JP); Kota WATANABE, Owariasahi (JP)

(73) Assignee: TOSHIBA LIFESTYLE PRODUCTS & SERVICES CORPORATION, Kawasaki-shi (JP)

(21) Appl. No.: 16/346,582

(22) PCT Filed: Jun. 7, 2017
(86) PCT No.: PCT/JP2017/021222

§ 371 Date: May 1, 2019

(30) Foreign Application Priority Data
Nov. 9, 2016 (JP) 2016-219124

(51) Int. Cl. A47L 5/10; A47L 9/00; G05D 1/02

(52) U.S. Cl. CPC A47L 5/10; A47L 9/009; G05D 1/0246; A47L 2201/06; A47L 2201/022; A47L 2201/04; G05D 1/0274

(57) ABSTRACT

A vacuum cleaner that can perform cleaning after grasping a shape of a cleaning area, and perform cleaning more efficiently. The vacuum cleaner includes a main casing, a driving wheel, a travel control part, a cleaning unit, a periphery detection sensor, and a map generation part. The driving wheel enables the main casing to travel. The travel control part controls driving of the driving wheel to make the main casing travel autonomously. The cleaning unit performs cleaning. The periphery detection sensor detects a shape of a periphery area of the main casing. The travel control part controls the driving of the driving wheel to make the main casing perform a specified initial operation in a specified range, whereby the periphery detection sensor performs scanning. The map generation part generates a primary map of the cleaning area on the basis of the shape of the scanned periphery area.

### TECHNICAL FIELD

Embodiments described herein relate generally to a vacuum cleaner capable of traveling autonomously.

### BACKGROUND ART

Conventionally, a so-called autonomous-traveling type vacuum cleaner (cleaning robot) which cleans a floor surface as a cleaning-object surface while autonomously traveling on the floor surface has been known.

In one of the technologies to perform efficient cleaning, in such a vacuum cleaner, a size and a shape of a room to be cleaned, obstacles and the like are reflected for generation of a map (mapping), an optimum traveling route is set based on the generated map, and then traveling along the traveling route is performed. This map is generated based on, for example, an image captured by a camera disposed on a main casing.

In the case of generation of a map, in general, maps are generated sequentially based on the obstacles detected based on the captured images, while a previously-specified travel control is performed from a start position for cleaning. Accordingly, this may be inefficient in some cases. Therefore, a series of operation from the map generation to the determination of a cleaning operation based on the generated map are required to be improved in efficiency. Further, since a vacuum cleaner travels along a traveling route which is previously set regardless of the shape of the room to be cleaned at the time of generating a map, the vacuum cleaner appears to travel at random to a user, and thus the performance of the vacuum cleaner hardly appeals to a user.

### CITATION LIST

### Patent Literature

PTL 1: Japanese Patent Publication No. 5426603

### SUMMARY OF INVENTION

### Technical Problem

The technical problem of the present invention is to provide a vacuum cleaner capable of performing cleaning more efficiently, and also capable of appealing to a user because of performing of cleaning after grasping of a shape of a traveling place.

### Solution to Problem

A vacuum cleaner according to the present embodiment includes a main casing, a driving part, a travel controller, a cleaning unit, a periphery detection sensor, and a mapper. The driving part enables the main casing to travel. The travel controller controls driving of the driving part to make the main casing travel autonomously. The cleaning unit performs cleaning. The periphery detection sensor detects a shape of a periphery area of the main casing. The travel controller controls the driving of the driving part to make the main casing perform a specified initial operation in a specified range, whereby the periphery detection sensor performs scanning. The mapper generates a primary map of a traveling place on the basis of the shape of the scanned periphery area.

### BRIEF DESCRIPTION OF DRAWINGS

FIG. 1 is a block diagram showing a vacuum cleaner according to a first embodiment;

FIG. 2 is a perspective view showing a vacuum cleaning apparatus including the above vacuum cleaner;

FIG. 3 is a plan view showing the above vacuum cleaner as viewed from below;

FIG. 4 is an explanatory view schematically showing a method for calculating three-dimensional coordinates of an object by a periphery detection sensor of the above vacuum cleaner;

FIG. 5 is an explanatory view showing one example of an initial operation by the above vacuum cleaner;

FIG. 6 is an explanatory view showing one example of an additional scanning by the above vacuum cleaner;

FIG. 7 is an explanatory view showing another example of the additional scanning by the above vacuum cleaner;

FIG. 8 is an explanatory view showing yet another example of the additional scanning by the above vacuum cleaner;

FIG. 9 is an explanatory view showing yet another example of the additional scanning by the above vacuum cleaner;

FIG. 10 is an explanatory view showing one example of a cleaning operation by the above vacuum cleaner;

FIG. 11 is an explanatory view showing the next operation continued from the cleaning operation shown in FIG. 10 by the above vacuum cleaner;

FIG. 12 is an explanatory view showing the next operation continued from the cleaning operation shown in FIG. 11 by the above vacuum cleaner;

FIG. 13 is an explanatory view showing the next operation continued from the cleaning operation shown in FIG. 12 by the above vacuum cleaner;

FIG. 14 is a flowchart showing control by the above vacuum cleaner;

FIG. 15 is an explanatory view showing one example of a cleaning operation by a vacuum cleaner according to a second embodiment;

FIG. 16 is an explanatory view showing another example of the cleaning operation by the above vacuum cleaner; and

FIG. 17 is an explanatory view showing another example of the cleaning operation by the above vacuum cleaner.

### DESCRIPTION OF EMBODIMENT

Hereinbelow, the configuration of the first embodiment will be described with reference to the drawings.

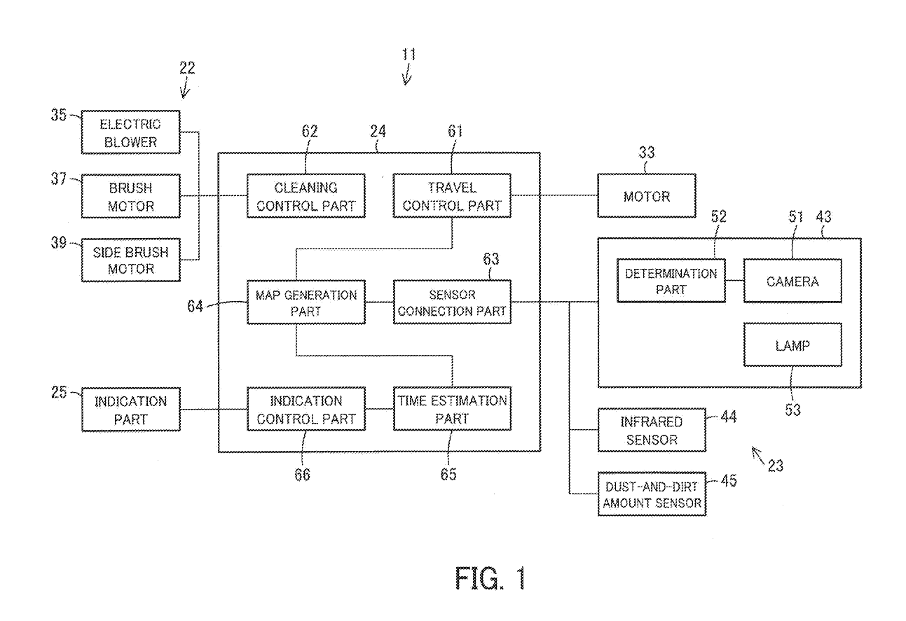

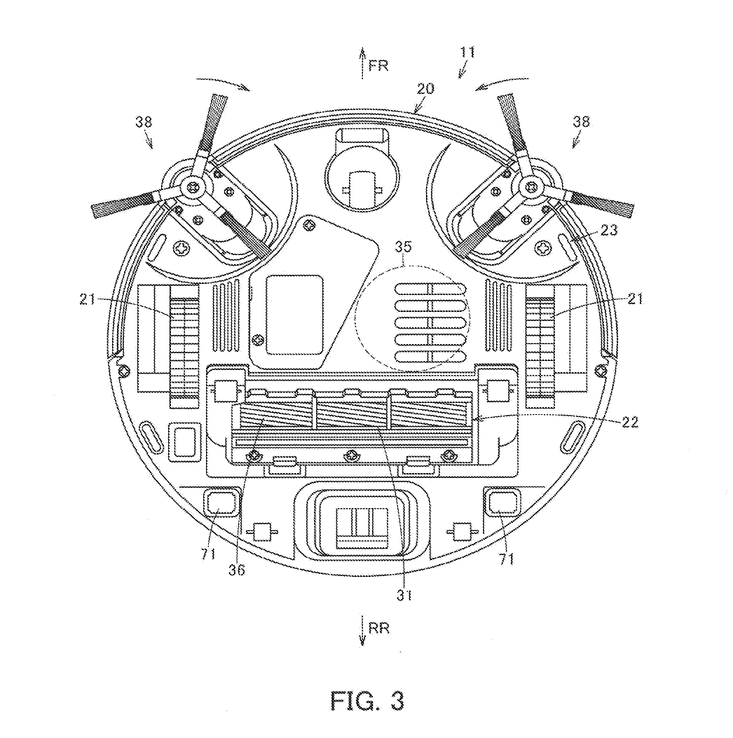

In FIG. 1 to FIG. 4, reference sign 11 denotes a vacuum cleaner as an autonomous traveler, and the vacuum cleaner 11 constitutes a vacuum cleaning apparatus (vacuum cleaner system) as an autonomous traveler device in combination with a charging device (charging table) 12 as a station device serving as a base station for charging the vacuum cleaner 11. Then, the vacuum cleaner 11 is, in the present embodiment, a so-called self-propelled robot cleaner (cleaning robot) which cleans a floor surface that is a cleaning-object surface as a traveling surface while autonomously traveling (being self-propelled to travel) on the floor surface.

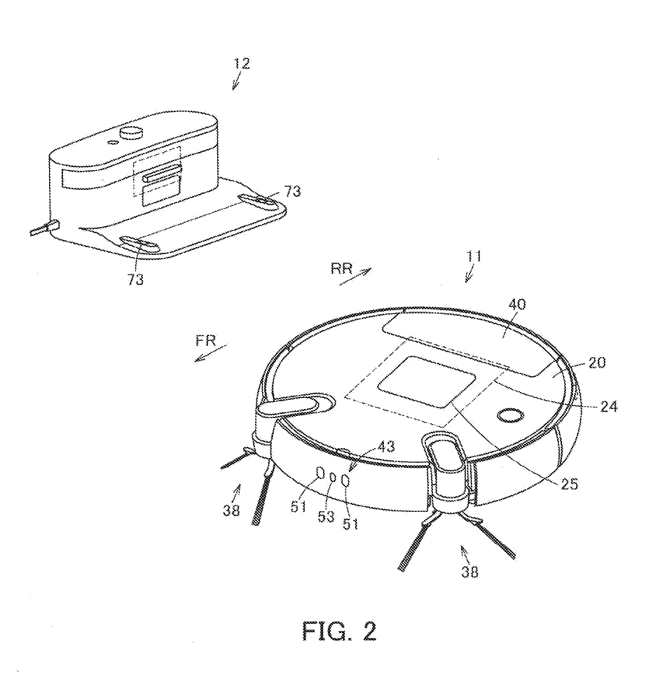

Then, the vacuum cleaner 11 includes a hollow main casing 20. The vacuum cleaner 11 also includes a driving wheel 21 as a driving part. Further, the vacuum cleaner 11 includes a cleaning unit 22 for cleaning dust and dirt. The vacuum cleaner 11 also includes a sensor part 23. The vacuum cleaner 11 further includes a control unit 24 as control means which is a controller. The vacuum cleaner 11 also includes an indication part 25 as informing means. Then, the vacuum cleaner 11 may include a secondary battery which is a battery for supplying electric power. Further, the vacuum cleaner 11 may include data communication means (a communication part) as information transmission means for performing, for example, wired or wireless communication via a network. The vacuum cleaner 11 may further include an input/output part through which signals are input and output with an external device and/or a user. In addition, the following description will be given on the assumption that a direction extending along the traveling direction of the vacuum cleaner 11 (main casing 20) is as a back-and-forth direction (directions of arrows FR and RR shown in FIG. 2), while a left-and-right direction (directions toward both sides) intersecting (orthogonally crossing) the back-and-forth direction is as a widthwise direction.

The main casing 20 is formed from a resin or the like, for example. The main casing 20 may be formed into, for example, a flat columnar shape (disc shape) or the like. The main casing 20 may also have a suction port 31 serving as a dust-collecting port on the lower portion thereof facing a floor surface.

The driving wheel 21 serves to make the vacuum cleaner (main casing 20) travel (autonomously travel) in an advancing direction and a retreating direction on a floor surface, that is, serves for traveling use. In the present embodiment, a pair of the driving wheels 21 is disposed, for example, respectively on the right and the left of the main casing 20. Each of the driving wheels 21 is driven by a motor 33 serving as driving means. In addition, a crawler or the like may be available as a driving part instead of the driving wheels 21.

The motor 33 is respectively disposed corresponding to each of the driving wheels 21. That is, in the present embodiment, a pair of the motors 33 is disposed, for example, respectively on the right and the left thereof. Then, each of the motors 33 is capable of driving each of the driving wheels 21 independently.

The cleaning unit 22 serves to remove dust and dirt on a cleaning-object part, for example, a floor surface, a wall surface and the like. The cleaning unit 22 has a function, for example, to collect and catch dust and dirt on a floor surface through the suction port 31, and/or to wipe a wall surface. The cleaning unit 22 may include at least one of an electric blower 35 which sucks dust and dirt along with air through the suction port 31, a rotary brush 36 as a rotary cleaner which is rotatably attached to the suction port 31 for scraping up dust and dirt, as well as a brush motor 37 which rotationally drives the rotary brush 36, and side brushes 38 which are auxiliary cleaning means (an auxiliary cleaning part) as swinging-cleaning parts rotatably attached on the both sides of the main casing 20 on its front side or the like to scrape together dust and dirt, as well as side brush motors 39 which drives the side brushes 38. The cleaning unit 22 may also include a dust-collecting unit 40 which communicates with the suction port 31 to collect dust and dirt.

The sensor part 23 serves to perform sensing with respect to various types of information to support the traveling of the vacuum cleaner 11 (main casing 20). More specifically, the sensor part 23 serves to perform sensing with respect to, for example, a pit-and-bump condition (a step gap) on a floor surface, a wall or an obstacle which hinders the traveling, an amount of dust and dirt on a floor surface, and the like. The sensor part 23 includes a periphery detection sensor 43. The sensor part 23 may also include, for example, an infrared sensor 44 and a dust-and-dirt amount sensor (dust sensor) 45.

The periphery detection sensor 43 serves to detect a shape of a periphery area of the main casing 20. The periphery detection sensor 43 includes a camera 51 serving as image capturing means. The periphery detection sensor 43 also includes a discrimination part 52. It is noted that the periphery detection sensor 43 may include a lamp 53 serving as detection assisting means (a detection assisting part).

The camera 51 is a digital camera which captures digital images of a forward direction corresponding to the traveling direction of the main casing 20, at each specified horizontal angle of view (for example 105° or the like) and at specified time intervals, for example, at a micro-time basis such as several tens of milliseconds or the like, or at a several-second basis or the like. The camera 51 may be of a single unit or a plurality of units. In the present embodiment, the cameras 51 are disposed in a pair respectively on the left and right sides. That is, the cameras 51 are disposed left and right apart from each other on the front portion of the main casing 20. Further, the cameras 51, 51 have their image capturing ranges (fields of view) overlapping with each other. Thus, the images captured by the cameras 51, 51 have their image capturing regions partially overlapping with each other in the left-and-right direction. It is noted that the images captured by the cameras 51 may be, for example, color images or black and white images of a visible light region, or may be infrared images.

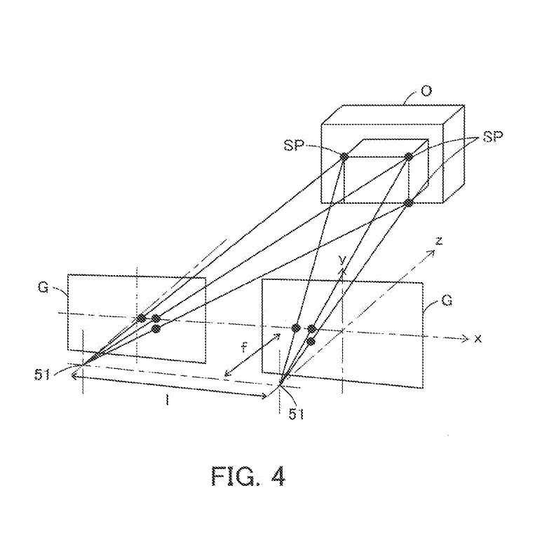

The discrimination part 52 is configured to extract feature points or the like from the images captured by the cameras 51, so as to detect a shape of an object (an obstacle or the like) (a distance to and a height of an object, and the like) positioned in the periphery of the main casing 20 based on the captured images. In other words, the discrimination part 52 is configured to determine whether or not the object calculated with respect to a distance from the main casing 20 based on the images captured by the cameras 51 is an obstacle. In an example, the discrimination part 52 is configured to calculate by a known method a distance (depth) and three-dimensional coordinates of an object (feature points) based on the images captured by the cameras 51 and the distance between the cameras 51. That is, specifically, the discrimination part 52 is configured to, by applying triangulation based on a distance f (parallax) between the cameras 51, 51 and an object O (feature points SP) in images G, G captured by the cameras 51, 51 and a distance I between the cameras 51, 51, detect pixel dots indicating identical positions each in individual images G, G captured by the cameras 51, 51, and calculate the angles of the pixel dots in the up-and-down direction, the left-and-right direction and the back-and-forth direction, thereby calculating the distance and the height of the position from the cameras 51 and also the three-dimensional coordinates of the object O (feature points SP) based on those angles and the distance I between the cameras 51, 51 (FIG. 4). The discrimination part 52 is also configured to compare the distance to the captured object, for example, in a specified image range (for example, an image range set corresponding to the width and height of the main casing 20) with a set distance corresponding to a threshold value previously set or variably set, so as to determine as an obstacle the object positioned at the set distance or closer (corresponding to the distance from the vacuum cleaner 11 (main casing 20)). It is noted that the discrimination part 52 may include an image correction function to perform initial image processing, for example, correction of lens distortion, noise elimination, contrast-adjusting, matching the centers of images and the like, with respect to the original images captured by the cameras 51. The discrimination part 52 may be disposed in the control unit 24. In addition, in the case where the camera 51 is of a single unit, the discrimination part 52 is capable of calculating a distance based on a moved amount in the coordinates of an object when the vacuum cleaner 11 (main casing 20) moves.

The lamp 53 serves to emit illuminating light to image capturing ranges of the cameras 51 to provide brightness required for capturing images. In the present embodiment, the lamp 53 is disposed at the intermediary position between the cameras 51, 51, corresponding to each of the cameras 51. For example, an LED or the like is available as the lamp 53.

The infrared sensor 44 is capable of detecting an obstacle or the like by emitting infrared rays toward the outside of the main casing 20, and utilizing the reflection waves of the emitted infrared rays having reflected at an object.

The dust-and-dirt amount sensor 45 is an optical sensor disposed, for example, in an upstream side of the dust-collecting unit 40, that is, in an air path continuing from the suction port 31 to the dust-collecting unit 40, or the like. The dust-and-dirt amount sensor 45 includes a light emitting part for emitting light and a light receiving part for receiving the light emitted from the light emitting part. Then, the dust-and-dirt amount sensor 45 is capable of detecting the amount of the dust and dirt passing through between the light emitting part and the light receiving part, based on the amount of light received by the light receiving part out of the light emitted by the light emitting part.

As the control unit 24, a microcomputer including, for example, a CPU which is a control means main body (control unit main body), a ROM, a RAM and the like is used. The control unit 24 includes a travel control part 61 serving as a travel controller for driving the driving wheels 21 (motors 33). The control unit 24 also includes a cleaning control part 62 serving as cleaning control means to be electrically connected to the cleaning unit 22. Further, the control unit 24 includes a sensor connection part 63 serving as sensor control means to be electrically connected to the sensor part 23. The control unit 24 also includes a map generation part 64 serving as a mapper (a mapping part). The control unit 24 further includes a time estimation part 65. The control unit 24 also includes an indication control part 66 serving as indication control means to be electrically connected to the indication part 25. That is, the control unit 24 is electrically connected to the cleaning unit 22, the sensor part 23, the indication part 25 and the like. The control unit 24 is also electrically connected to the secondary battery. In addition, the control unit 24 has, for example, a traveling mode for driving the driving wheels 21, that is, the motors 33 to make the vacuum cleaner 11 (main casing 20) travel autonomously, a charging mode for charging the secondary battery via the charging device 12, and a standby mode applied during a standby sate. Further, the control unit 24 may include a non-volatile memory, for example, a flash memory or the like. The control unit 24 may also include a charging control part for controlling the charging of the secondary battery.

The travel control part 61 controls the driving of the motors 33, that is, controls magnitudes and directions of current flowing through the motors 33 to rotate the motors 33 in a normal or reverse direction, thereby controlling the driving of the motors 33. By controlling the driving of the motors 33, the travel control part 61 controls the driving of the driving wheels 21. The travel control part 61 may be configured to set an optimum traveling route based on the map generated by the map generation part 64 which is described below. Here, as an optimum traveling route to be generated, a route which can provide efficient traveling (cleaning) is set, such as a route which can provide the shortest traveling distance for traveling in an area enabled to be cleaned in the map (an area excluding a part where traveling is impossible due to an obstacle, a step gap or the like), for example, a route by which the vacuum cleaner 11 (main casing 20) travels straight as long as possible (by which directional change is least required), a route by which contact with an object as an obstacle is less, a route by which the number of times of redundantly traveling the same location is the minimum, or the like. The travel control part 61 is also capable of changing a traveling route at anytime according to an obstacle detected by the sensor part 23 (the periphery detection sensor 43 and the infrared sensor 44). Further, the travel control part 61 is also capable of setting a traveling speed and a traveling route of the vacuum cleaner 11 (main casing 20) based on a residual amount of the secondary battery. In the case where the residual amount of the secondary battery is insufficient, as an example, the speed of the vacuum cleaner (main casing 20) may be set relatively higher, thereby enabling to clean a wider cleaning area for a short period of time.

The cleaning control part 62 controls the driving of the electric blower 35, the brush motor 37 and the side brush motors 39 of the cleaning unit 22, that is, controls the conduction amounts of the electric blower 35, the brush motor 37 and the side brush motors 39 independently of one another, thereby controlling the driving of the electric blower 35, the brush motor 37 (rotary brush 36) and the side brush motors 39 (side brushes 38). The cleaning control part 62 is also capable of controlling the driving of the electric blower 35, the brush motor 37 and the side brush motors 39, based on the residual amount of the secondary battery. In an example, in the case where the residual amount of the secondary battery is insufficient, the driving of the electric blower 35, the brush motor 37 and the side brush motors 39 is lowered, thereby enabling to suppress the consumed amount of the secondary battery.

The sensor connection part 63 serves to acquire a detection result done by the sensor part 23 (the periphery detection sensor 43, the infrared sensor 44 and the dust-and-dirt amount sensor 45). The sensor connection part 63 may also have a function of an image capturing control part to control the operation of the cameras 51 (a shutter operation or the like) to make the cameras 51 capture images at specified time intervals, and/or a function of an illumination control part to control the operation of the lamp 53 (turning-on and -off operation).

The map generation part 64 serves to generate a map indicating whether or not the traveling is possible in the cleaning area based on the shape (a distance to and a height of an object as an obstacle) in the periphery area of the main casing 20 detected by the periphery detection sensor 43. Specifically, the map generation part 64 determines the self-position of the vacuum cleaner 11 and the presence or absence of an object as an obstacle, and also generates a map indicating the positional relations and the heights of objects (obstacles) and the like positioned in the cleaning area where the vacuum cleaner 11 (main casing 20) is positioned, based on the three-dimensional coordinates of the feature points of the objects in the images captured by the cameras 51. That is, a known SLAM (simultaneous localization and mapping) technology is available for the map generation part 64.

The time estimation part 65 is configured to estimate an expected cleaning time to be required for cleaning based on the map generated by the map generation part 64. Specifically, the time estimation part 65 is configured to estimate an expected cleaning time in accordance with the size (area) of the map generated by the map generation part 64, based on the size of the vacuum cleaner 11 (main casing 20) and the average traveling speed of the vacuum cleaner 11 (main casing 20).

The indication control part 66 performs control so as to indicate various types of information on the indication part 25. In an example, the indication control part 66 is capable of indicating on the indication part 25 an expected cleaning time estimated by the time estimation part 65, an elapsed time from cleaning start, a residual cleaning time, an expected cleaning end time obtained through calculation based on cleaning time, or the like.

The input/output part serves to acquire a control command transmitted from an unshown external device such as a remote control, and/or a control command input from input means such as a switch or a touch panel which are disposed on the main casing 20, and also transmit a signal to, for example, the charging device 12 or the like. The input/output part includes unshown transmission means (a transmission part), for example, an infrared ray emitting element or the like, which transmits a radio signal (infrared signal) to, for example, the charging device 12 or the like, and unshown reception means (a reception part), for example, a phototransistor or the like, which receives a radio signal (infrared signal) from the charging device 12, a remote control or the like.

The second battery serves to supply electric power to the cleaning unit 22, the sensor part 23, the control unit 24, the indication part 25 and the like. The secondary battery is electrically connected to charging terminals 71 serving as connection parts exposed, for example, on the lower portion or other portion of the main casing 20. With the charging terminals 71 electrically and mechanically connected to the charging device 12 side, the secondary battery is charged via the charging device 12.

The charging device 12 is equipped with a charging circuit, for example, a constant current circuit or the like. The charging device 12 also includes terminals for charging 73 for charging the secondary battery. The terminals for charging 73 which are electrically connected to the charging circuit are to be electrically and mechanically connected to the charging terminals 71 of the vacuum cleaner 11 having returned to the charging device 12.

The external device is a general-purpose device, for example, a PC (tablet terminal (tablet PC)), a smartphone (mobile phone) or the like, which is capable of, inside a building, performing wired or wireless communication with a network via a home gateway, for example, and outside a building, performing wired or wireless communication with a network. The external device may have an indication function to indicate images.

Next, the operation of the above-described first embodiment is described with reference to the drawings.

In general, the work of the vacuum cleaning apparatus is roughly divided into cleaning work in which the vacuum cleaner 11 performs cleaning, and charging work in which the charging device 12 charges the secondary battery. The charging work is implemented by a known method using a charging circuit contained in the charging device 12. Therefore, only the cleaning work is described. In addition, image capturing work in which the cameras 51 capture images of a specified object in response to an instruction from the external device or the like may be included separately.

First, the cleaning work is roughly described from the start to the end. When the cleaning is started, the vacuum cleaner 11 scans a cleaning area as a traveling place, at a position where the vacuum cleaner 11 having been connected to the charging device 12 undocks from the charging device 12, or at the present position of the vacuum cleaner 11 not being connected to the charging device 12. That is, the vacuum cleaner 11 performs a specified initial operation without moving (traveling) from the position at the time of scanning before the start of cleaning. In the case where a map is not stored in a memory, a primary map is generated based on the scanning. In the case where a map is stored in a memory, the stored map is compared with the primary map generated based on the scanning, and thereby the map of the cleaning area are checked with regard to change and the self-position. In the present embodiment, as for the generation of the primary map, the originally generated map based on the scanning in the cleaning area (initial scanning) is expanded and updated through additional scanning when required. That is, in the present embodiment, before the start of the cleaning operation, the map generation part 64 generates the utmost detailed primary map. Then, the vacuum cleaner 11 sets a traveling route based on the map, and updates the map at any time to complete the map while traveling along the set traveling route during cleaning. When the cleaning is finished, the vacuum cleaner 11 returns to the charging device 12, and then the procedure thereof moves to the charging work for the secondary battery.

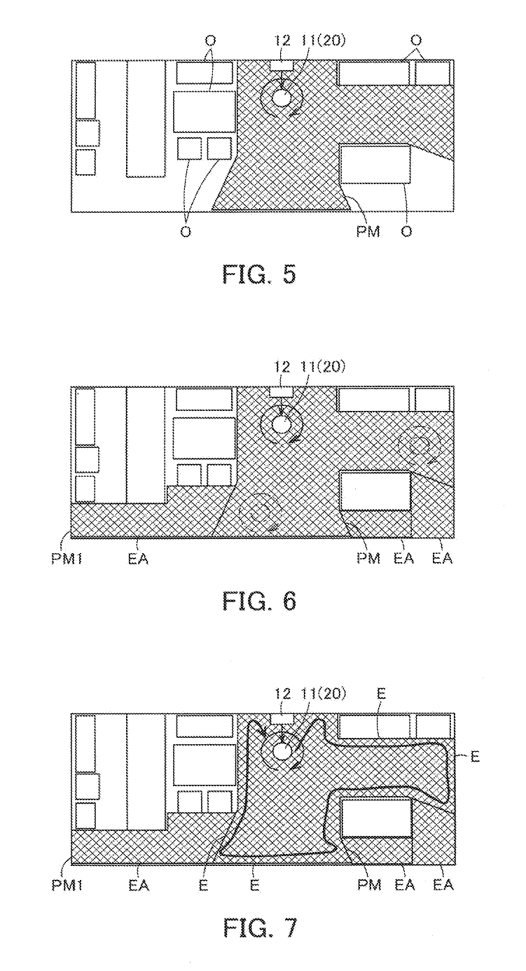

The above-described control is described more specifically. In the vacuum cleaner 11, the control unit 24 is switched over from the standby mode to the traveling mode, at a timing of, for example, arrival of a preset cleaning start time, or reception by the input/output part of the control command for cleaning start transmitted by a remote control or the external device. Then, in the case of the vacuum cleaner 11 being connected to the charging device 12, the travel control part 61 controls the driving of the driving wheels 21 (motors 33) so that the vacuum cleaner 11 undocks from the charging device 12 and travels straight by a specified distance, and then the cleaning area is scanned (initial scanning). At the time of the scanning, the travel control part 61 controls the driving of the driving wheels 21 (motors 33) to make the main casing 20 perform the specified initial operation in a specified range, and thereby the vacuum cleaner 11 generates the primary map of the cleaning area based on the shape of the periphery area scanned by the periphery detection sensor 43. The specified range described above refers to a range previously set regardless of the shape (size) of the cleaning place. In the present embodiment, in an example, the travel control part 61 controls the driving of the driving wheels 21 (motors 33) so that the main casing 20 (vacuum cleaner 11) performs swinging operation by a specified angle, for example, 360 degrees (FIG. 5). That is, in the present embodiment, the vacuum cleaner 11 performs scanning at the present position without moving from the scanning start position. In the present embodiment, the swinging operation refers to the operation in which, in an example, the travel control part 61 rotates one of the driving wheels 21 (motors 33) and the other of the driving wheels 21 (motors 33) reversely with each other so that the vacuum cleaner 11 (main casing 20) swings (pivot-turns) at the present position. This enables to acquire as a primary map PM the cleaning area excluding a place to be a shadow of an object (obstacle) 0 seen by the vacuum cleaner 11 (main casing 20).

In the present embodiment, after the initial scanning, additional scanning is further performed. When the cleaning area as a traveling place is further detected in the outer part of the primary map, the primary map is updated and expanded. That is, in the initial scanning, in the case where a piece of furniture, for example, a sofa or the like is disposed in the cleaning area, the place to be, as it were, the shadow of the piece of furniture seen from the position of the vacuum cleaner 11 is impossible to be detected by the periphery detection sensor 43, and thus the additional scanning is performed so that the cleaning area not having been detected in the initial scanning is reflected in the primary map.

The operation of the vacuum cleaner 11 at the time of the additional scanning may include various types of operation, for example, checking the traveling place in the outer part of the primary map by swinging at a plurality of positions in the primary map (plural-times swinging), checking the traveling place in the outer part of the primary map while traveling along an edge part of the primary map (edge-part traveling), checking the traveling place in the outer part of the primary map while traveling in the range of the primary map (internal traveling), and checking the traveling place in the outer part of the primary map after traveling to a position away from the present position at an edge part of the primary map (remote-part traveling).

In an example, in the case of the above-described plural-times swinging (FIG. 6), in the range of the primary map PM generated in the initial scanning, the travel control part 61 controls the driving of the driving wheels 21 (motors 33) to make the main casing 20 move to a plurality of positions, and then the periphery detection sensor 43 detects a shape (obstacle) of the outer part of the primary map PM while the travel control part 61 controls the driving of the driving wheels 21 (motors 33) at each of the plurality of positions to swing the main casing 20 at each position, so that the cleaning area as a traveling place positioned in the outer part of the primary map PM is checked.

Further, in the case of the above-described edge-part traveling (FIG. 7), in the range of the primary map PM generated in the initial scanning, the periphery detection sensor 43 detects a shape of the outer part of the primary map PM while the travel control part 61 controls the driving of the driving wheels 21 (motors 33) to make the main casing 20 travel along an edge part E of the primary map PM, so that a cleaning area EA positioned in the outer part of the primary map PM is checked.

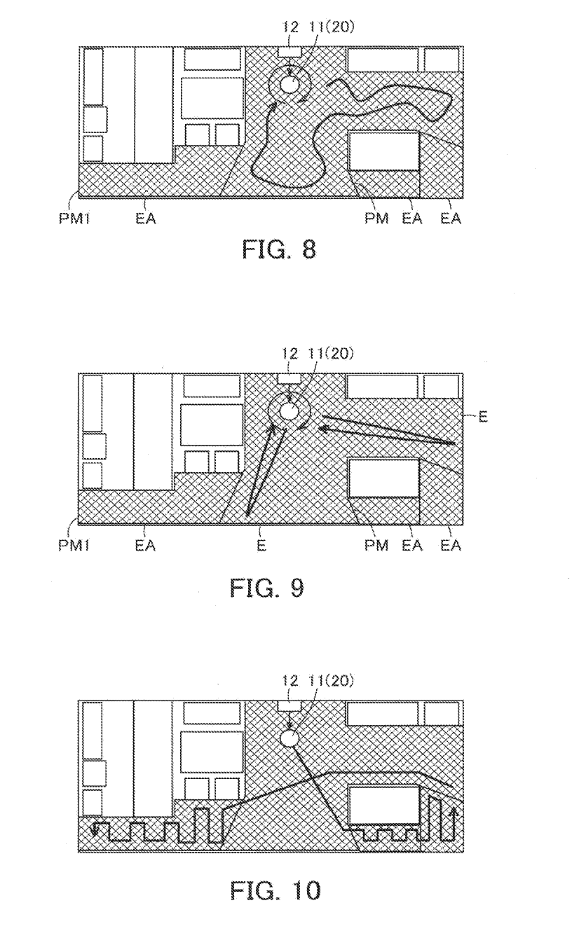

In addition, in the case of the above-described internal traveling (FIG. 8), in the range of the primary map PM generated in the initial scanning, the periphery detection sensor 43 detects a shape of the outer part of the primary map PM while the travel control part 61 controls the driving of the driving wheels 21 (motors 33) to make the main casing 20 travel, so that the cleaning area EA positioned in the outer part of the primary map PM is checked. In this case, in the present embodiment, the vacuum cleaner 11 (main case 20) is made travel at random in the range of the primary map PM. However, the vacuum cleaner 11 (main case 20) may be made travel regularly, for example, in zigzags or the like.

Further, in the case of the above-described remote-part traveling (FIG. 9), in the periphery of the edge part E of the primary map PM generated in the initial scanning, after the travel control part 61 controls the driving of the driving wheels 21 (motors 33) to make the vacuum cleaner 11 (main casing 20) travel to a position away from the present position, the periphery detection sensor 43 detects a shape of the outer part of the primary map PM so that the cleaning area EA positioned in the outer part of the primary map PM is checked. It is noted that, the position away from the present position refers to, for example, the farthest position, the second farthest position or the like from the position of the vacuum cleaner 11 (main casing 20) at the edge part E of the primary map PM.

These types of operation are desirably selected based on the shape of the primary map PM and the product specifications such as of how to show the operation by the vacuum cleaner 11 to a user. Alternately, the types of operation may be combined with each other, or plural types of operation may be implemented arbitrarily and sequentially.

Then, when the cleaning area EA is detected in the outer part of the range of the primary map PM, the map generation part 64 adds the cleaning area EA to the primary map PM to generate a primary map PM1 through updating. It is noted that the primary map PM1 is stored in a memory included in the control unit 24 or the like.

After generation of the primary map, the travel control part 61 sets a traveling route based on the primary map.

On the other hand, in the case where the vacuum cleaner 11 is not connected to the charging device 12, the vacuum cleaner 11 performs the same types of operation and control as those described above, excluding the undocking operation from the charging device 12, and then sets a traveling route. That is, in the case where the vacuum cleaner 11 is not connected to the charging device 12, the vacuum cleaner 11 may be brought to be used in an area different from the area having been cleaned at the previous time, for example, to be used on a different floor. Thus, the present place must be checked with regard to whether the present place and the cleaning area at the previous time are the same or different from each other. In this case, the vacuum cleaner 11 scans the cleaning area by use of the periphery detection sensor 43 in the same manner as the case where the vacuum cleaner 11 is connected to the charging device 12, and then, in the case where a map is not stored in a memory, generates the primary map in the scanning, or in the case where a map is stored in a memory, compares the stored map with the primary map generated in the scanning to check the map of the cleaning area with regard to change and the self-position.

In addition the time estimation part 65 estimates a cleaning time based on the map, and the indication control part 66 indicates an indication relevant to the estimated cleaning time on the indication part 25.

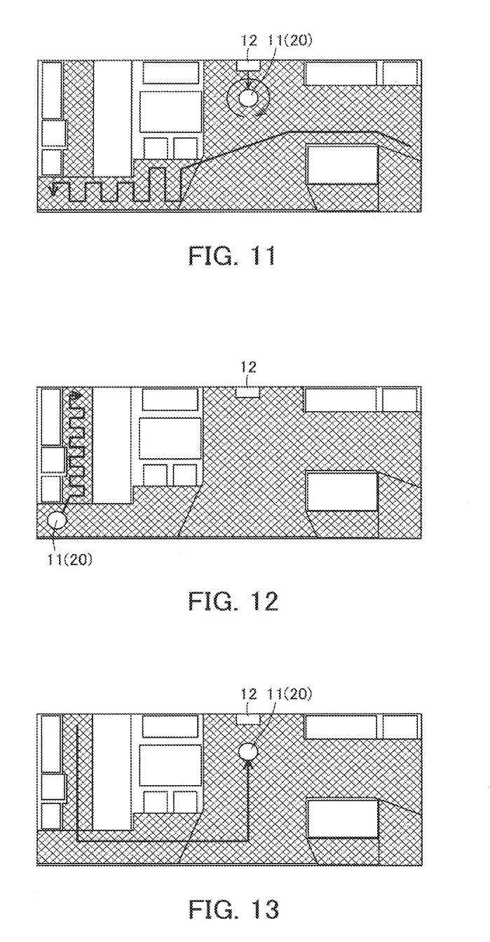

Then, the travel control part 61 controls the driving wheels 21 (motors 33) to make the main casing 20 autonomously travel along the set traveling route, and also the cleaning control part 62 makes the cleaning unit 22 operate to clean the floor surface in the cleaning area (cleaning mode). As for the cleaning unit 22, in an example, the electric blower 35, the brush motor 37 (rotary brush 36) or the side brush motors 39 (side brushes 38) driven by the control unit 24 (cleaning control part 62) collects dust and dirt existing on the floor surface to the dust-collecting unit 40 through the suction port 31. Further, in the vacuum cleaner 11, when the periphery detection sensor 43 or the infrared sensor 44 of the sensor part 23 detects, during the autonomous traveling, three-dimensional coordinates and a position of an object not shown on the primary map as an obstacle or the like in the cleaning area, the map generation part 64 reflects the detection to the map and stores the reflected map in a memory (FIG. 10 to FIG. 12). The control unit 24 is also capable of increasing and decreasing a driving force of the electric blower 35, the rotary brush 36 (brush motor 37) or the side brushes 38 (side brush motors 39) according to the dust-and-dirt amount detected by the dust-and-dirt amount sensor 45, the type of the floor surface, and the like. In the case where the dust-and-dirt amount detected by the dust-and-dirt amount sensor 45 is large, as an example, the driving force described above is increased. In the case where the dust-and-dirt amount is relatively small, the driving force is decreased.

After traveling the entire set traveling route, the vacuum cleaner 11 finishes the cleaning operation, and the travel control part 61 controls the driving of the driving wheels 21 (motors 33) so that the vacuum cleaner 11 returns to the charging device 12 (FIG. 13). Then the vacuum cleaner is connected to the charging device 12 (the charging terminals 71 and the terminals for charging 73 are mechanically and electrically connected), and the procedure thereof is switched over to a charging operation at a specified timing such as when a specified time elapses after the connection.

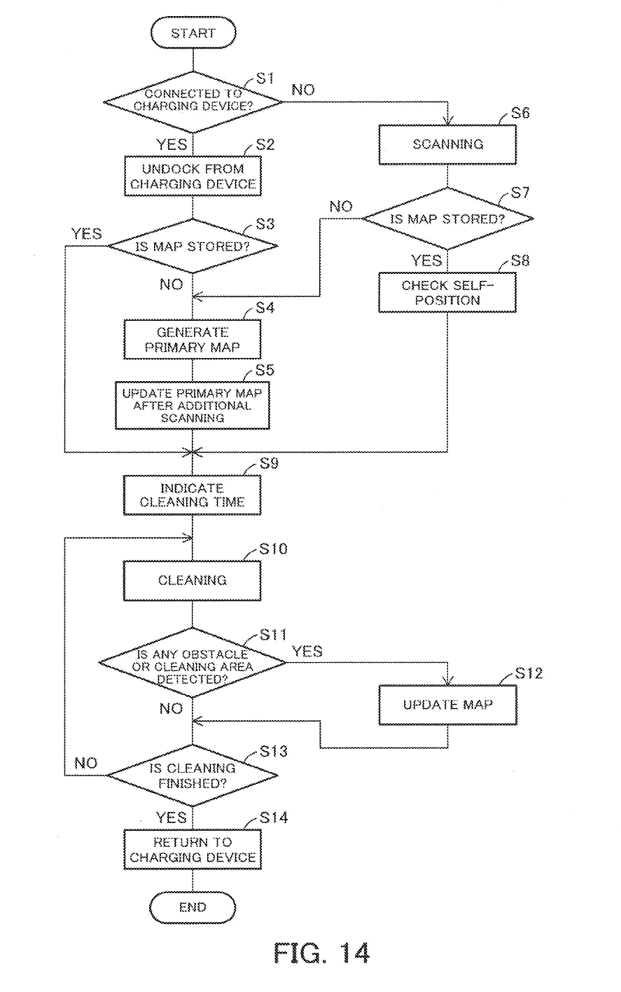

The above operation and control are described with reference to the flowchart shown in FIG. 14. First, when the cleaning is started, the control unit 24 determines whether or not the vacuum cleaner 11 is connected to the charging device 12 (Step S1). In Step S1, in the case where it is determined that the vacuum cleaner 11 is connected to the charging device 12, the travel control part 61 controls the driving of the driving wheels 21 (motors 33) to make the vacuum cleaner 11 (main casing 20) undock from the charging device 12 (Step S2). Then, the map generation part 64 determines whether or not a map is stored in a memory (Step S3). In Step S3, in the case where it is determined that a map is not stored in a memory, in the vacuum cleaner 11, the periphery detection sensor 43 scans the cleaning area by detecting a shape of the periphery area, while the travel control part 61 controls the driving of the driving wheels 21 (motors 33) to make the vacuum cleaner 11 (main casing 20) perform a specified initial operation (for example, swinging), and then the map generation part 64 generates the primary map (Step S4). Then, in the vacuum cleaner 11, the periphery detection sensor 43 additionally scans the cleaning area by detecting the shape of the periphery area, while the travel control part 61 controls the driving of the driving wheels 21 (motors 33) to make the vacuum cleaner 11 (main casing 20) perform a specified operation, and then the map generation part 64 updates the primary map (Step S5).

On the other hand, in Step S1, in the case where it is determined that the vacuum cleaner 11 is not connected to the charging device 12, in the vacuum cleaner 11, the periphery detection sensor 43 scans the cleaning area by detecting the shape of the periphery area, while the travel control part 61 controls the driving of the driving wheels 21 (motors 33) to make the vacuum cleaner 11 (main casing 20) perform a specified initial operation (for example, swinging) (Step S6). Then, the map generation part 64 determines whether or not a map is stored in a memory (Step S7). In Step S7, in the case where it is determined that a map is not stored, the procedure goes to Step S4. In the case where it is determined that a map is stored, the map generation part 64 checks the self-position, that is, grasps the present position (Step S8), by comparing the shape of the periphery area detected through the scanning in Step S6 with the stored map, and then the procedure goes to Step S9. It is noted that, some obstacles, for example, a chair and the like positioned in the cleaning area may not be at a fixed position. Thus, in Step S8, in the case where the map stored in the memory is different from the shape of the periphery area detected through the scanning in Step S6, the stored map may be updated after reflection to the map.

Then, in the vacuum cleaner 11, the time estimation part 65 estimates the cleaning time based on the map and indicates the estimation on the indication part 25 (Step S9), and the cleaning unit 22 performs cleaning (Step S10). Then, the periphery detection sensor 43 or the like detects the shape of the periphery area, and thereby the map generation part 64 determines whether or not any obstacle or cleaning area not shown on the map has been detected (Step S11). Further, in Step S11, when determining that such an obstacle or cleaning area has been detected, the map generation part 64 updates the map (Step S12), and the procedure goes to Step S13. In the case where the traveling route requires to be changed based on the updated map, the travel control part 61 resets the traveling route. In Step S11, when determining that such an obstacle or cleaning area has not been detected, the travel control part 61 determines whether or not the entire traveling route has been traveled, that is, whether or not the cleaning is finished (Step S13). In Step S13, in the case where it is determined that the cleaning is not finished, the procedure goes back to Step S10, while in the case where it is determined that the cleaning is finished, the travel control part 61 controls the driving of the driving wheels 21 (motors 33) to make the vacuum cleaner 11 (main casing 20) return to the charging device 12 (Step S14), and thereby the cleaning is finished.

As described above, according to the above first embodiment, the travel control part 61 controls the driving of the driving wheels 21 to make the main casing 20 perform a specified initial operation in a specified range, and thereby the periphery detection sensor 43 scans the shape of the periphery area. In the primary map of the cleaning area generated based on the scanned shape by the periphery detection sensor 43, the entire cleaning area may not be detected. Thus, the primary map is updated (expanded) through additional scanning, and thereby a detailed primary map is enabled to be generated before the start of the cleaning. Accordingly, such setting of the traveling route or the like by the travel control part 61 becomes more accurate according to the actual cleaning area, thereby enabling to perform cleaning more efficiently in every corner of the cleaning area.

In the case where, as an example, after the initial scanning, the cleaning area in the outer part of the primary map is checked by using the periphery detection sensor 43 while the travel control part 61 controls the driving of the driving wheels 21 to swing the main casing 20 at each of a plurality of positions, the accuracy of the primary map is enabled to be improved further.

Further, in the case where, after the initial scanning, the map generation part 64 checks the cleaning area in the outer part of the primary map while the travel control part 61 controls the driving of the driving wheels 21 to make the main casing 20 travel along the edge part of the primary map, whether or not the cleaning area spreads farther from the edge part of the primary map is enabled to be checked easily.

In the case where, after the initial scanning, the map generation part 64 checks the cleaning area in the outer part of the primary map while the travel control part 61 controls the driving of the driving wheels 21 to make the main casing 20 travel in the range of the primary map, the vacuum cleaner 11 (main casing 20) travels, as it were, wandering around in the range of the primary map, and thereby the cleaning area in the outer part of the primary map is enabled to be checked easily.

In the case where, the travel control part 61 controls the driving of the driving wheels 21 to make the main casing 20 travel to a position away from the present position at the edge part of the primary map, and then the map generation part 64 checks the cleaning area in the outer part of the primary map, whether or not the cleaning area spreads farther from the edge part of the primary map is enabled to be checked easily.

When the cleaning area in the outer part of the primary map is detected, the map generation part 64 updates the primary map, thus enabling to improve the accuracy of the map.

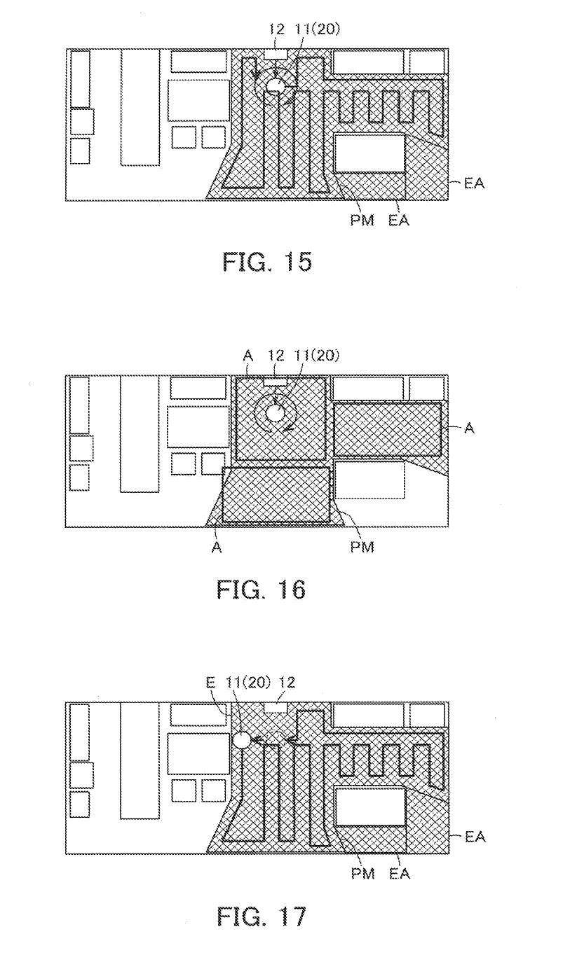

Next, the second embodiment is described with reference to FIG. 15 to FIG. 17. It is noted that, as for the same configuration and operation as the above-described first embodiment, the same reference number is imparted and its description is omitted.

In the second embodiment, after generating the primary map after the start of the cleaning in the above-described first embodiment, the vacuum cleaner 11 updates the map at any time to complete the map while performing cleaning during traveling along the traveling route set based on the primary map without performing the operation to expand (update) the primary map. That is, in the present embodiment, after the scanning (initial scanning) for generating the primary map, the procedure moves directly to the cleaning operation without performing of the additional scanning. In other words, in the present embodiment, the period of time required for generation of the primary map is reduced so that the cleaning is started in an early stage, and the map is being updated at any time during cleaning. Accordingly, in the second embodiment, Step S5 of the flowchart shown in FIG. 14 in the above-described first embodiment is omitted.

The travel control part 61 is capable of, based on the primary map or the map stored in a memory, arbitrarily setting a traveling route, for example, a traveling route (zigzag traveling route) for traveling in zigzags in the area enabled to be cleaned, a traveling route (area traveling route) for traveling in each area where the primary map (map) is divided into a plurality of areas, a traveling route (periphery traveling route) for moving to an edge part close to the present position in the primary map (map) and then traveling from the position as a base, or other route.

In the case of the zigzag traveling route (FIG. 15), as an example, a route which can provide efficient traveling (cleaning) is set, so that the travel control part 61 controls the driving of the driving wheels 21 (motors 33) to allow the main casing 20 to travel at the shortest traveling distance in the area enabled to be cleaned (area excluding the area where traveling is impossible due to an obstacle, a step gap or the like) in the primary map PM (map), for example, a route by which the vacuum cleaner 11 (main casing 20) travels straight as long as possible (by which directional change is least required), a route by which contact with an object as an obstacle is less, a route by which the number of times of redundantly traveling the same location is the minimum, or the like.

Further, in the case of the area traveling route (FIG. 16), for example, the travel control part 61 or the map generation part 64 divides the primary map PM (map) into a plurality of areas A, and sets a traveling route such as a zigzag traveling route for each area A. In addition, in the case where the residual amount of the secondary battery is insufficient for cleaning while traveling all of the areas Ain the primary map PM (map), as an example, a traveling route may be set based on the residual amount of the secondary battery, so that only some areas A out of the plurality of areas A is to be cleaned preferentially.

In addition, in the case of the periphery traveling route (FIG. 17), a traveling route is set so that, at a position in a periphery of the edge part E in the primary map PM (map), the travel control part 61 controls the driving of the driving wheels 21 (motors 33) to make the vacuum cleaner 11 (main casing 20) travel to a position close to the present position, and then perform, for example, traveling in zigzags in the cleaning area from the position as a base. It is noted that, the position close to the present position, at the edge part E in the primary map PM (map), as an example, refers to the closest position, the second closest position or the like from the position of the vacuum cleaner 11 (main casing 20).

Then, when the cleaning area EA is detected in the outer part of the range of the primary map PM during cleaning, the cleaning area EA is added to the primary map PM so that the map is updated at any time. The travel control part 61 is also capable of resetting the traveling route through addition and revision of the traveling route based on the updated map.

As described above, when the primary map is generated through scanning of the cleaning area in a specified initial operation (swinging), the procedure moves directly to the cleaning of the area enabled to be cleaned in the primary map. This enables to reduce the period of time required for generation of the primary map, resulting in enabling to start cleaning in an early stage.

That is, in the case where the most part of the cleaning area has been scanned at the time of scanning for generation of the primary map, the period of time required for the additional scanning may be wasted. Accordingly, starting the cleaning without additional scanning is more effective to the efficient cleaning. Especially, in the case of the vacuum cleaner 11 having the secondary battery as a power source, the capacity of the secondary battery is effectively utilized since the capacity of the secondary battery required for the additional scanning is reduced.

In the case where, as an example, after the map generation part 64 generates the primary map, the cleaning unit 22 performs cleaning while the travel control part 61 controls the driving of the driving wheels 21 to make the main casing 20 travel in the range of the primary map, the area enabled to be cleaned in the range of the primary map is enabled to be cleaned first, thereby enabling to reduce the period of time required for cleaning, resulting in improving the efficiency of the cleaning.

In addition, in the case where, after the map generation part 64 generates the primary map, the cleaning unit 22 performs cleaning while the travel control part 61 controls the driving of the driving wheels 21 to make the main casing 20 travel sequentially in each divided area in the primary map, the primary map is divided into a plurality of small areas, thereby enabling to make the vacuum cleaner 11 travel efficiently.

In addition, in the case where, after the map generation part 64 generates the primary map, the cleaning unit 22 performs cleaning while the travel control part 61 controls the driving of the driving wheels 21 to make the main casing 20 move to the closest edge part in the primary map and then travel in the range of the primary map, the cleaning is enabled to start from the closest edge part in an early stage.

In addition, in the above-described second embodiment, the traveling route set by the travel control part 61 is enabled to be applied to the above-described first embodiment.

Further, in each of the above-described embodiments, the map data may be transmitted to a server via data communication means through a network for storage in the server, not only in a memory, or may be transmitted to a memory of an external device for storage or indication on the external device.

In addition, any configuration may be applied as the periphery detection sensor 43, in order to detect three-dimensional coordinates of an object, for example, a configuration by use of a laser or the like, not only the configuration using the cameras 51.

Further, as the informing means, for example, voice output means (a voice generating part) for performing informing by voice or the like is available, not only the indication part 25 for performing indication by image or the like.

In addition, as described above, the travel control part 61, the cleaning control part 62, the sensor connection part 63, the map generation part 64, the time estimation part 65, the indication control part 66 and the like are included in the control unit 24, but may be included separately, or may be combined integrally and arbitrarily.

According to at least one of the above-described embodiments, the travel control part 61 controls the driving of the driving wheels 21 to make the main casing 20 perform a specified initial operation in a specified range, and thereby the periphery detection sensor 43 performs scanning. The primary map of the cleaning area is generated based on the shape of the periphery area scanned by the periphery detection sensor 43. This enables to set a traveling route easily and accurately based on the primary map, resulting in improving the efficiency of the cleaning. Further, since a user can see the vacuum cleaner 11 scanning the periphery area in a specified initial operation (swinging), the vacuum cleaner 11 performing cleaning while recognizing the shape of the cleaning area, not performing cleaning at random in the cleaning area, enables to appeal to a user.

Further, when the map generation part 64 generates the primary map, the travel control part 61 controls the driving of the driving wheels 21 to swing the main casing 20, and thus the shape of the periphery area of the main casing 20 is enabled to be detected easily. In addition, scanning of the cleaning area appeals to a user, resulting in improving the merchantability thereof.

Then, the cleaning time is indicated on the indication part 25 for informing, and thus a user is informed of an approximate cleaning time, resulting in improving the merchantability thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

(1) A travel control method for a vacuum cleaner, comprising the steps of scanning a shape of a periphery area by performing a specified initial operation in a specified range, and generating a primary map of a traveling place based on the scanning.

(2) The travel control method for the vacuum cleaner according to (1), comprising the step of swinging when generating the primary map.

(3) The travel control method for the vacuum cleaner according to (2), comprising the step of checking the traveling place in an outer part of the primary map by a periphery detection sensor while swinging at each of a plurality of positions.

(4) The travel control method for the vacuum cleaner according to any one of (1) to (3), comprising the step of checking the traveling place in the outer part of the primary map by the periphery detection sensor while making a main casing travel along an edge part of the primary map.

(5) The travel control method for the vacuum cleaner according to any one of (1) to (3), comprising the step of checking the traveling place in the outer part of the primary map by the periphery detection sensor while making a main casing travel in a range of the primary map.

(6) The travel control method for the vacuum cleaner according to any one of (1) to (3), comprising the step of checking the traveling place in the outer part of the primary map by the periphery detection sensor after making a main casing travel to a position away from a present position at an edge part of the primary map.

(7) The travel control method for the vacuum cleaner according to any one of (4) to (6), comprising the step of updating the primary map when detecting the traveling place in the outer part of the primary map.

(8) The travel control method for the vacuum cleaner according to any one of (1) to (7), comprising the step of, after generating the primary map, performing cleaning while traveling in the range of the primary map.

(9) The travel control method for the vacuum cleaner according to any one of (1) to (7), comprising the step of, after generating the primary map, performing cleaning while traveling sequentially in each divided area in the primary map.

(10) The travel control method for the vacuum cleaner according to any one of (1) to (7), comprising the steps of, after generating the primary map, moving to a closest edge part in the primary map, and performing cleaning while traveling in the range of the primary map.

(11) The travel control method for the vacuum cleaner according to any one of (8) to (10), comprising the step of updating the primary map at any time while traveling even during cleaning.

(12) The travel control method for the vacuum cleaner according to any one of (1) to (11), comprising the step of estimating a cleaning time based on a size of the primary map for informing.

1. A vacuum cleaner comprising:
a main casing;
a driving part for enabling the main casing to travel;
a travel controller for controlling driving of the driving part to make the main casing travel autonomously;
a cleaning unit for performing cleaning;
a periphery detection sensor for detecting a shape of a periphery area of the main casing; and
a mapper for generating a primary map of a traveling place on the basis of the shape of the periphery area scanned by the periphery detection sensor, wherein the travel controller controls the driving of the driving part to make the main casing perform a specified initial operation in a specified range, whereby the periphery detection sensor scans the periphery area.

2. The vacuum cleaner according to claim 1, wherein
the travel controller controls the driving of the driving part to swing the main casing when the mapper generates the primary map.

3. The vacuum cleaner according to claim 2, wherein
the mapper checks the traveling place in an outer part of the primary map by use of the periphery detection sensor while the travel controller controls the driving of the driving part to make the main casing swing at each of a plurality of positions.

4. The vacuum cleaner according to claim 1, wherein
the mapper checks the traveling place in the outer part of the primary map by use of the periphery detection sensor while the travel controller controls the driving of the driving part to make the main casing travel along an edge part of the primary map.

5. The vacuum cleaner according to claim 1, wherein
the mapper checks the traveling place in the outer part of the primary map by use of the periphery detection sensor while the travel controller controls the driving of the driving part to make the main casing travel in a range of the primary map.

6. The vacuum cleaner according to claim 1, wherein
the mapper checks the traveling place in the outer part of the primary map by use of the periphery detection sensor, after the travel controller controls the driving of the driving part to make the main casing travel to a position away from a present position at an edge part of the primary map.

7. The vacuum cleaner according to claim 4, wherein
the mapper updates the primary map when detecting the traveling place in the outer part of the primary map.

8. The vacuum cleaner according to claim 1 to claim 7, wherein
after the mapper generates the primary map, the cleaning unit performs cleaning while the travel controller controls the driving of the driving part to make the main casing travel in the range of the primary map.

9. The vacuum cleaner according to claim 1, wherein
after the mapper generates the primary map, the cleaning unit performs cleaning while the travel controller controls the driving of the driving part to make the main casing travel sequentially in each divided area of the primary map.

10. The vacuum cleaner according to claim 1, wherein
after the mapper generates the primary map, the cleaning unit performs cleaning while the travel controller controls the driving of the driving part to make the main casing travel in the range of the primary map, after making the main casing move to a closest edge part of the primary map.

11. The vacuum cleaner according to claim 8, wherein
the mapper updates the primary map at any time, even while the travel controller controls the driving of the driving part to make the main casing travel and the cleaning unit performs cleaning.

12. The vacuum cleaner according to claim 1, the vacuum cleaner comprising:
an informing part for estimating a cleaning time based on a size of the primary map for informing.

13. A travel control method for a vacuum cleaner, comprising:
scanning a shape of a periphery area by performing a specified initial operation in a specified range; and
generating a primary map of a traveling place based on the scanning.
